(19) United States
(12) Patent Application Publication
(10) Pub. No.: US 2017/0169078 A1
(43) Pub. Date: Jun. 15, 2017

(54) Log Mining with Big Data

(71) Applicant: Siemens Aktiengesellschaft, Munich (DE)

(72) Inventors: Dmitriy Fradkin, Wayne, PA (US); Quang Nguyen, Princeton, NJ (US); Bogdan Rosca, Princeton, NJ (US); Sindhu Suresh, Monroe Twp., NJ (US)

(21) Appl. No.: 15/370,206

(22) Filed: Dec. 6, 2016

Related U.S. Application Data
(60) Provisional application No. 62/266,859, filed on Dec. 14, 2015.

(51) Int. Cl. G06F 17/30

(52) U.S. Cl. CPC G06F 17/30539; G06F 17/30194; G06F 17/30283

(57) ABSTRACT

A system for performing data mining on log record data includes a distributed processing system comprising a plurality of distributed nodes, each node having at least one of a storage device and a data processing device and a distributed data analytics processor configured to perform queries on a set of log records to select at least a portion of the log records and store the selected log records in a plurality of the distributed nodes, wherein the distributed data analytics processor is further configured to perform data analysis on the selected log records stored in the plurality of distributed nodes. The distributed nodes may be arranged in a cluster, with each node being in communication with each other node through a distributed file system. The processor may perform analysis on data stored across the distributed nodes with the processing being performed by a plurality of the distributed nodes in parallel.

### CROSS REFERENCE TO RELATED APPLICATIONS

This application claims the benefit of priority under 35 U.S.C. §119(e) to U.S. Provisional Patent Application Ser. No. 62/266,859 entitled, “LOG MINING WITH BIG DATA”, filed Dec. 14, 2015, which is incorporated by reference herein in its entirety.

### TECHNICAL FIELD

Aspects of this application relate to data analytics. More particularly, aspects of this application relate to analyzing log data in a distributed system.

### BACKGROUND

Traditionally, the problems of preventative maintenance and diagnosis of failures have been addressed through conventional technologies using single node processing, including relational databases and the like. As the volume of data increases with developing technology, these traditional techniques become less computationally feasible.

Many entities utilize log mining. Log mining is the analysis of logs that are produced by a number of pieces of equipment. Log mining is utilized to improve customer service, to perform predictive maintenance, diagnose problems, and identify failures. As technology advances, logs are created by numerous components within complex systems. The data contained in these logs is voluminous and requires advanced technological techniques for efficient processing and analysis of the log data.

Improved systems and methods are needed which address these shortcomings.

### SUMMARY

A system for data mining log record data includes a distributed data processing system comprising a plurality of distributed nodes, each node having at least one of a storage device and a data processing device. A distributed data analytics processor selects certain log records from a set of log records and stores the selected log records in a plurality of the distributed nodes. The distributed data analytics processor performs data analysis on the selected log records stored in the plurality of distributed nodes. The distributed nodes may be arranged in a cluster. The distributed nodes are in communication with one another through a distributed file system. The distributed data analytics processor is configured to at least in part control the communication between a first distributed node and a second distributed node.

In one embodiment, the distributed data analytics processor is configured to add a new node and to store a portion of the selected log records in a storage device of the new node.

According to another embodiment, the distributed data analytics processor is configured to produce information corresponding to suggested predictive patterns representative of information contained in the set of log records. The suggested predictive patterns may relate to at least one instance of a specific failure of an operation unit, or the suggested predictive patterns may relate to a normal utilization model of an operational unit.

In another embodiment, the distributed data analytics processor is configured to perform analysis on the selected log record data using the processing device of a plurality of the distributed nodes simultaneously in parallel.

In another embodiment, a method for performing data mining on log record data comprises the steps of, in a distributed data analytics processor, selecting a plurality of log records from a set of log records then storing the selected log records in a plurality of distributed nodes and performing data analysis on the selected log records, wherein the analysis is performed in part by at least one data processing device associated with one of the plurality of distributed nodes.

In another embodiment a non-transitory computer readable medium storing computer instructions that when executed by a processor cause the processor to perform the steps of in a distributed data analytics processor, selecting a plurality of log records from a set of log records, storing the selected log records in a plurality of distributed nodes; and performing data analysis on the selected log records, wherein the analysis is performed in part by at least one data processing device associated with one of the plurality of distributed nodes.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram illustrating data entities according to embodiments of the present disclosure.

FIG. 2 is a graphical illustration of a log containing equipment unit log data according to embodiments of the disclosure.

FIG. 3 is a graphical illustration of a table containing notification records.

FIG. 4 is a block diagram of an exemplary computer system which may be configured as a special purpose machine for performing log data mining according to embodiments of the disclosure.

FIG. 5 is a process flow diagram illustrating a method of log data mining according to embodiments of the disclosure.

FIG. 6 is a block diagram of a log data mining system according to embodiments of the disclosure.

### DETAILED DESCRIPTION

Big Data technologies and paradigms, which operate on distributed systems, may be utilized to efficiently perform log mining tasks on multiple nodes in parallel, thereby making log mining possible on large scale data. Methods according to embodiments of this disclosure are applicable across multiple domains, for example, logs relating to medical, mobility and power-generation may be mined, by way of non-limiting example.

The utility of log mining for failure diagnosis, predictive maintenance and other applications is well recognized in industry. Until recently, traditional technologies such as relational databases, single node processing, and the like have been used to address the problems of preventative maintenance and diagnosis. But due to the growth of data volume in recent times, these approaches have become less and less computationally feasible.

Embodiments of the invention utilize Big Data technologies to efficiently scale up log mining. All stages of the process are considered, including data storage, data pre-processing and data mining itself.

Conventional log mining typically involves objects and processes. Objects define or contain information about physical objects. The information relating to or contained in objects provides data for further processing. Processing includes operations that construct problem instances, which typically correspond to a time window reflecting operational information for a given duration within a specific operational unit. Identifying information from the data associated with the objects is extracted and mapped to instances. Instances correspond to events which are used for analysis and future actions in response to the events. Analysis is implemented to process the data and produce useful information that addresses a recognized business need. By way of one non-limiting example, event instances relating to failures of a particular type of machine may be extracted from general log information. Information collected during timeframes during and near the identified failures may present patterns, which in turn, provide information which can be used to identify imminent failures or suggest service intervals for ongoing maintenance.

Objects include physical objects or equipment or operational units, which are defined by a physical object such as a machine, controller, actuator and the like. Numerous operational units may be arranged or associated to create a system of operational units. Each operational unit includes processes or utilities for monitoring operation of the operational unit and generating log information based on various operational states of the operational unit. Log information may be saved in the form of log records, which are stored in log files. Alternatively, the log information may be used to populate a database containing the log information. Records containing the log information may also be treated as objects. Service notifications or other information that serve to identify a failure may also be stored in files or entered into a database to create additional objects representative of system or equipment states. For example, information relating to predictions of specific failure types or other information needed for supervised scenarios may be stored for later retrieval and analysis.

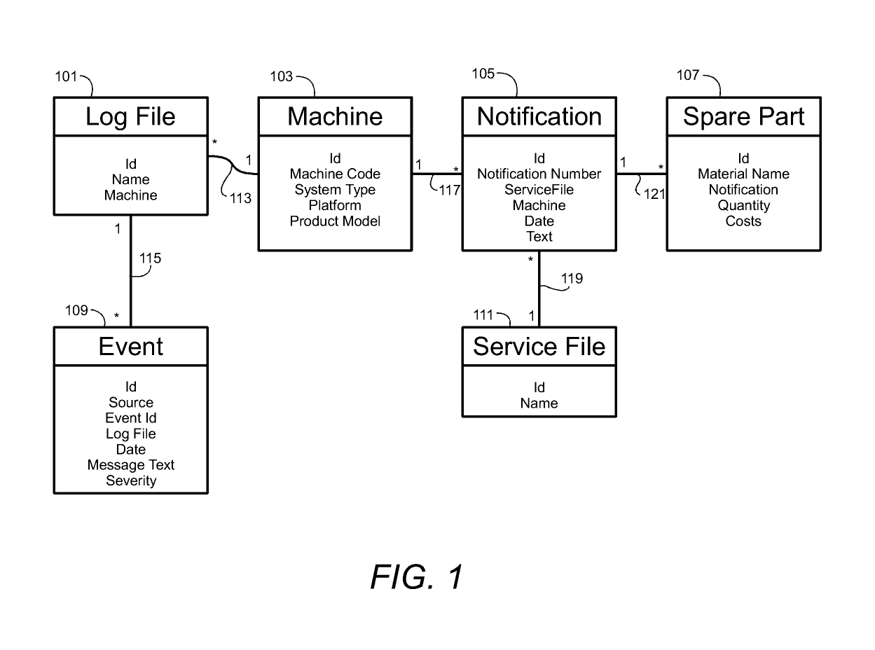

The methods and manufactures described herein may be used to perform system log data mining across multiple operational platforms. A high-level data model of a system for applying the methods of the present invention is shown in FIG. 1. The data model of FIG. 1 is provided by way of illustrative example only and is not intended to limit the scope of this disclosure. Those of skill in the art will recognize that other data models, containing additional or different data entities may be conceived which remain within the scope of the present disclosure.

FIG. 1 is a data model entity relationship diagram according to one embodiment representing system generated data. Entity 101 depicts a log file. Each instance of a log file is described using the fields or attributes included in the entity 101. For example, a log file may be identified by a unique Id field, a name identifying the log file, and an identifier or pointer to a machine entity 103. The machine entity 103 may be defined using attributes including: a unique ID, a machine code, system type, platform, and product model. The log file entity 101 and the Machine entity 103 are linked by relationship 113. Relationship 113 indicates a one-to-many relationship between machines and log files, denoted by the numeral “1” provided next to the machine entity 103, and the asterisk (*) provided next to the log file entity 101. This relationship 113 denotes that each log file 101 instance is associated with only one machine 103, while a machine 103 instance may be associated with a plurality of log files 101.

Still referring to FIG. 1, an event entity 109 may be identified by the following attributes: a unique Id, source, event Id, a log file entity 101, date, message text, and severity. An event entity 109 may be related to a log file entity 101 through a many-to-one relationship 115. This means that one log file 101 may be associated with or contain multiple events 109, however, each event instance 109 is associated with only one log file 101.

FIG. 1 further illustrates a notification entity 105, which may be defined by the following attributes: unique ID, notification number, service file entity 111, machine entity 103, date, and text. A spare part entity 107 may be identified by attributes: unique Id, material name, notification entity 105, quantity, and cost. Finally, service file entity 111 may be identified by attributes: unique Id and name. Notification entity 105 is related to machine entity 103 in a many-to-one relationship 117. Further, notification entity 105 is related to service file entity 111 by many-to-one relationship 119, and to spare part entity in one-to-many relationship 121. Accordingly, each instance of a notification entity 105 identifies a specific machine. However instances of a notification entity 105 may be included in each service file instance, and likewise each notification instance 105 may be associated with multiple spare part instances. That is, a notification instance may indicate a need for multiple spare parts via an associated service file. Likewise, a service file may refer to more than one notification instance.

Aspects of the present invention allow for entities 101, 103, 105, 107, 109, and 111 to be identified by other attributes.

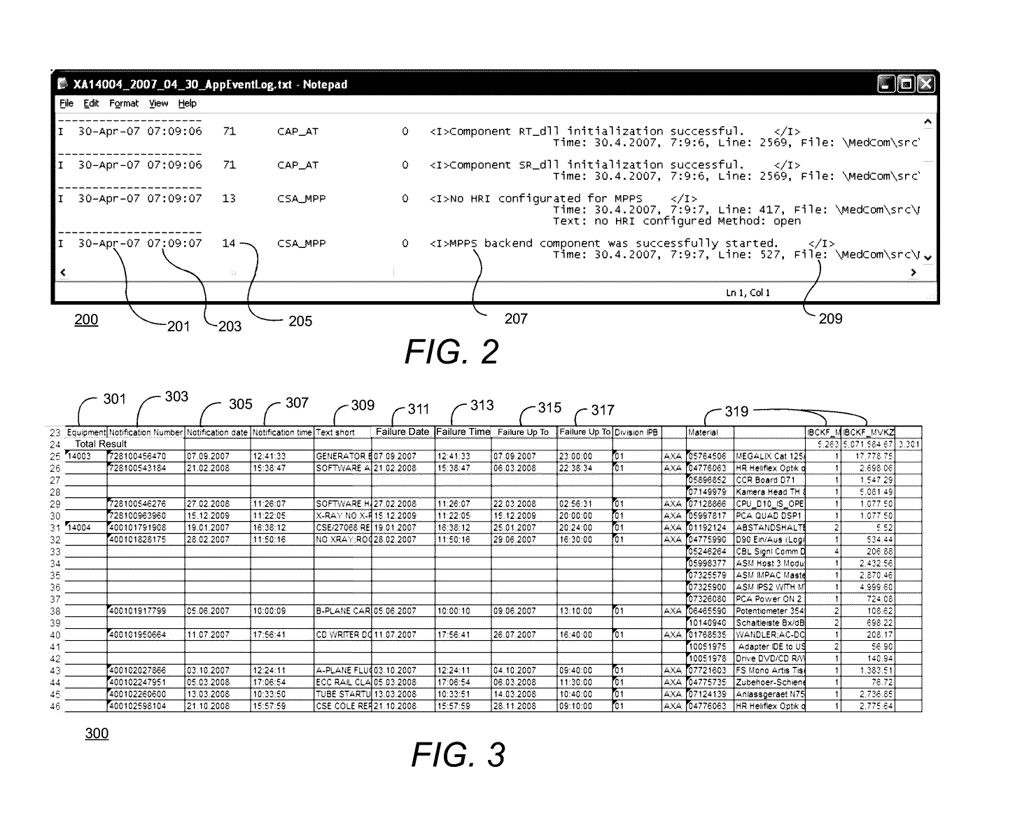

Referring now to FIG. 2 an illustration of a log file 200 is shown. The log file may contain multiple entries. Four entries are shown and listed vertically in the example of FIG. 2. Each entry includes the date 201 and time 203 of the entry, an event code 205 representing a category of the logged event, textual information describing to the entry 207 and the filename 209 containing the entry.

Service or maintenance notifications (or tickets) may be used by a Customer Service Center for recording detailed information on performed maintenance or repairs. An example of a notification 300 is illustrated in FIG. 3. Information including the instrument identification 301, notification open date 305 and time 307 are included in the notification. In addition, information relating to a failure may be included in the notification such as the beginning date 311 and time 313 of the failure, and the date 315 and time 317 the failure is resolved. The notification record may also include identifying information of spare parts 319 consumed during the maintenance or repair. Spare part consumption may be used to identify when and where a specific component fails or requires maintenance under normal conditions.

In conventional systems, the data associated with the log files and notifications shown in FIG. 2 and FIG. 3 may be stored in single node solutions, such as a relational database. But the use of relational databases and a single node approach to processing is subject to a number of disadvantages. For example, due to the data being processed in a single node, the scaling of the process is very difficult. Consider a case in which a new piece of equipment is added. The new equipment creates new log data. This additional log data may be the subject of additional notification data. In a single node environment, this data must be captured and imported to the database. Subsequently, tables or queries in the database must be modified and possibly re-run to accommodate the additional equipment.

The data schema in the relational database is fixed, thereby reducing flexibility. Further, while running queries on small stores of data is not problematic; these operations create bottlenecks when they are being performed on large or massive data stores. In an environment where systems are increasingly becoming interconnected, data is shared across distributed networks. As systems become more interconnected, these systems include more devices. Each device generates log information at a substantial rate. Therefore, the data stores containing this information become massive. For example, a query may require extraction of portions of a data store which has become very large as the overall data store grows. Moreover, complex analysis is difficult to perform in a single node environment, requiring additional exportation of data. Data exportation requires additional resources such as additional storage and configuration of additional network systems for connecting the analysis tools to the extracted data.

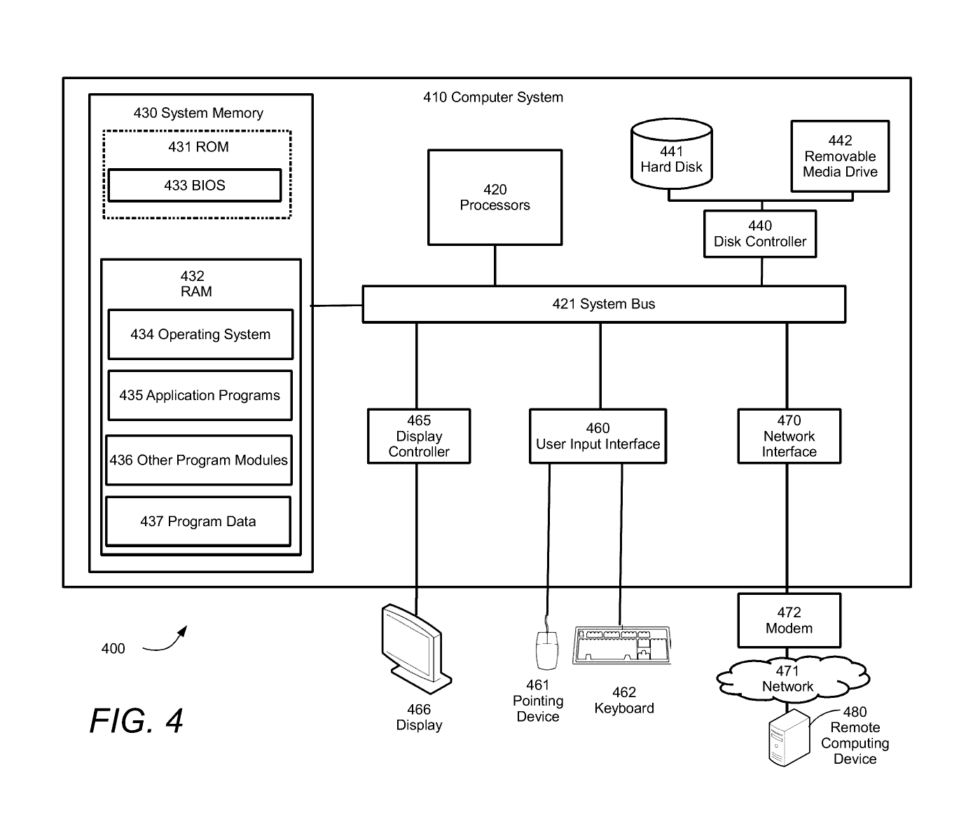

FIG. 4 is a block diagram of a system on which embodiments of this disclosure may be implemented. FIG. 4 illustrates an exemplary computing environment 400 within which embodiments of the invention may be implemented. Computers and computing environments, such as computer system 410 and computing environment 400, are known to those of skill in the art and thus are described briefly here.

As shown in FIG. 4, the computer system 410 may include a communication mechanism such as a system bus 421 or other communication mechanism for communicating information within the computer system 410. The computer system 410 further includes one or more processors 420 coupled with the system bus 421 for processing the information.

The processors 420 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 4, the computer system 410 also includes a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, other program modules 436 and program data 437.

The computer system 410 also includes a disk controller 440 coupled to the system bus 421 to control one or more storage devices for storing information and instructions, such as a magnetic hard disk 441 and a removable media drive 442 (e.g., floppy disk drive, compact disc drive, tape drive, and/or solid state drive). Storage devices may be added to the computer system 410 using an appropriate device interface (e.g., a small computer system interface (SCSI), integrated device electronics (IDE), Universal Serial Bus (USB), or FireWire).

The computer system 410 may also include a display controller 465 coupled to the system bus 421 to control a display or monitor 466, such as a cathode ray tube (CRT) or liquid crystal display (LCD), for displaying information to a computer user. The computer system includes an input interface 460 and one or more input devices, such as a keyboard 462 and a pointing device 461, for interacting with a computer user and providing information to the processors 420. The pointing device 461, for example, may be a mouse, a light pen, a trackball, or a pointing stick for communicating direction information and command selections to the processors 420 and for controlling cursor movement on the display 466. The display 466 may provide a touch screen interface which allows input to supplement or replace the communication of direction information and command selections by the pointing device 461.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium, such as a magnetic hard disk 441 or a removable media drive 442. The magnetic hard disk 441 may contain one or more data stores and data files used by embodiments of the present invention. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

The computing environment 400 may further include the computer system 710 operating in a networked environment using logical connections to one or more remote computers, such as remote computing device 480. Remote computing device 780 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

Processes according to embodiments of the present disclosure perform log mining in three steps. First, the data to be analyzed is stored for processing. The data may be exported from a distributed operations system and moved onto a cluster of one or more distributed storage devices. The storage devices may further include processing abilities. For example, the data to be analyzed may be transferred to a storage device associated with a computer workstation or server. Further, a plurality of storage devices may be organized as a cluster. Each storage device or workstation in the cluster is configured to operate in communication with each other storage device or workstation in the cluster via a distributed operating system. For example, a distributed operating system, which may be used in embodiments of the present invention, is HADOOP®, a distributed operating system provided by THE APACHE™ SOFTWARE FOUNDATION. Data for analysis may be stored using a distributed file system, which is optimized for distributed systems and processing. By way of non-limiting example, the HADOOP DISTRIBUTED FILE SYSTEM (HPFS™) may be used to store the data for analysis in each of the distributed storage devices.

Second, pre-processing is performed on the collected data. In log mining, the units of analysis tend to be time-windows associated with specific machines. For example, in a scenario where the desire is to identify or learn search patterns or to build a predictive model for predicting a failure of a specific type F, each occurrence of failure F within the fleet or system is associated with a time window corresponding to the machine on which the failure F occurred. These failures may be identified in notification records, which identify a type of failure and the machine affected. To provide meaningful predictive information, log data may be identified and selected for an affected machine in a time window occurring at some pre-determined time period prior to the identified failure. For completeness, additional records containing “negative” data, or data from time periods far removed from the time of failure F may be identified for further analysis. In another embodiment, the goal may be the development of a normal utilization model for particular types of equipment or for normal utilization under specific operating conditions. By identifying specific machines and dates/times of interest, appropriate log data may be identified for later analysis.

After the data selected for analysis has been identified, an appropriate formulation may be developed, for example, representing instances as a sequence of events, or as vectors in high-dimensional attribute space for a set of attributes (e.g., statistics on event occurrences). Pre-processing of the analysis data may be performed using distributed paradigms which allow the selection of records from the equipment units of interest that fall within a determined time window, [T₁, T₂], within a specified date. For instance, a key may be defined from an operational unit and failure date. This identifies records corresponding to the failure on a specific operational unit and groups them into appropriate instances for analysis. Depending of the analysis method chosen, the output after identifying records of interest may be a return of selected original records. In another embodiment, aggregated statistics for the selected time window may be returned.

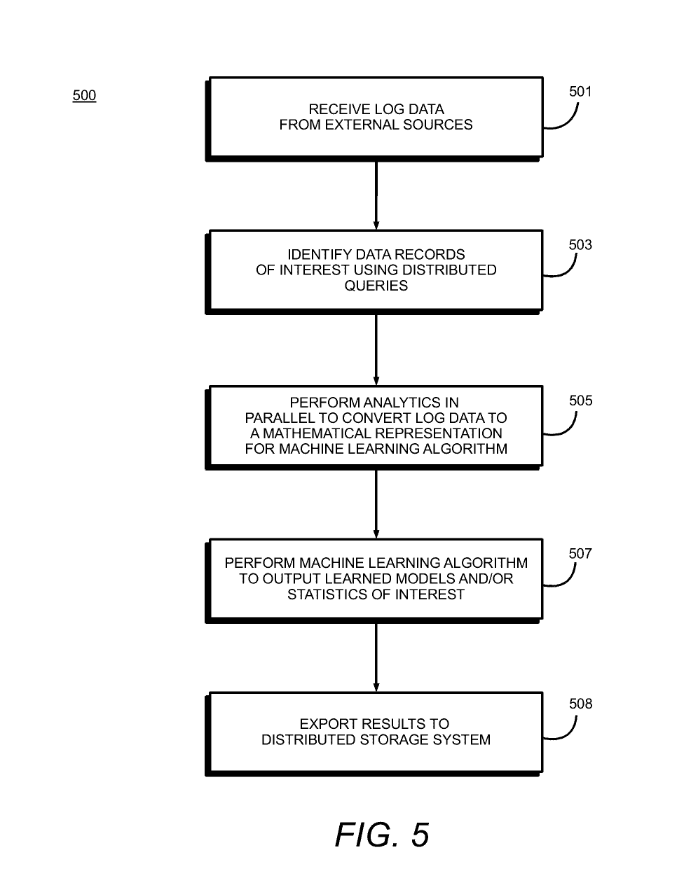

FIG. 5 is a process flow diagram of a method for log mining in a distributed processing system. At step 501, log data that is selected for analysis is received in a distributed processing system. When the data is received in the distributed processing system, the data may be arranged according to machine and date. In this way, records associated with specific time windows for a selected machine are easy to locate. The data is received and stored across a plurality of nodes. Each node may be configured to store a portion of the received log data. Each node is associated with each other node through the distributed processing file system. All received log data may be accessed and processed through the distributed processing service regardless of the physical location (e.g. node) where the log data is stored. Once the log information has been stored in the distributed processing system, distributed queries may be performed on the log data to identify the records of interest 503. For example, records relating to time windows associated with an identified failure type may be identified for further analysis or pattern matching to determine operational conditions that may have led to a particular type of failure. When the log information is contained within a massive store of data, the use of a distributed processing system allows for the queries to be run simultaneously (e.g., in parallel) across multiple storage nodes.

When the data which is to be further analyzed has been identified, analytic processing is performed in parallel across multiple nodes, converting the log information or event notifications into a mathematical representation that is compatible with a machine learning algorithm 505. The machine learning algorithm receives the processed log information, processed to identify maintenance and failure conditions. The machine learning algorithm may perform additional calculations or analysis to determine factors that lead to or result from various states captured in the log data. The analytics are performed across different data nodes simultaneously via the distributed processing system. This allows multiple processing resources to work together across separate data locations or nodes thereby reducing the time required to process massive volumes of data while not overloading any single processing node. This prevents lags and bottlenecks associated with the processing of large volumes of data. By using embodiments described in this specification, data analysis that traditionally would require approximately one week to perform on a conventional single node configuration may instead be processed and completed in a matter of hours.

The machine learning algorithm is executed on the converted data to create or generate learned models or statistics of interest 507. Generated models are representative of the system from which the original log data was acquired and provide additional information relating to processes or occurrences that lead to failures or maintenance issues. The generated models or statistics are generated and stored in the distributed storage system 508 for later retrieval. The output models and/or statistics may be used at a later time for prediction of maintenance needs under normal use, or to predict future failures based on prior patterns leading to such failures.

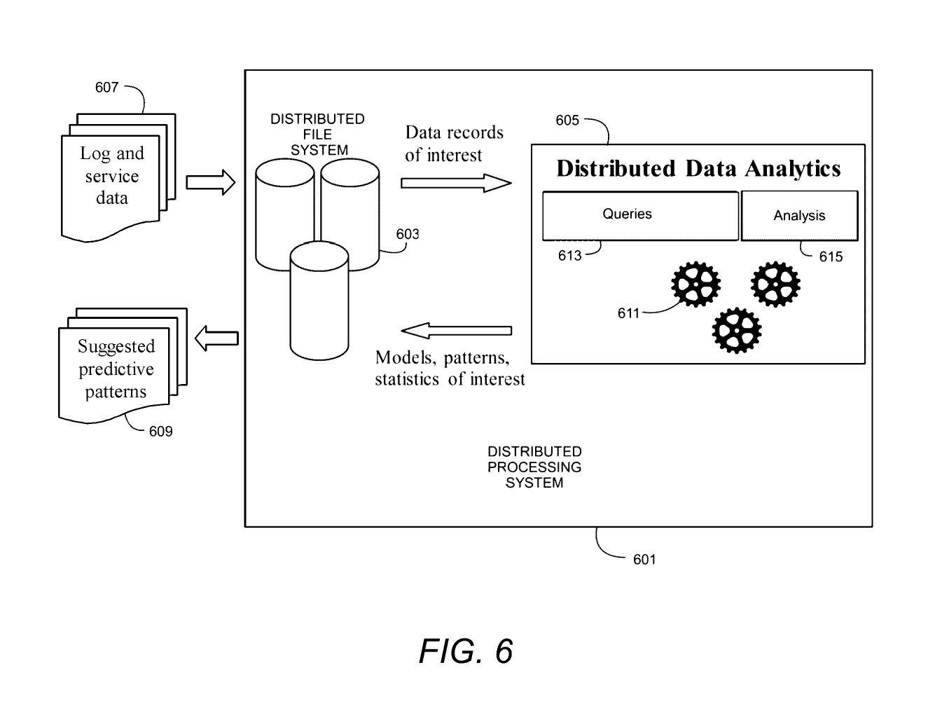

Referring now to FIG. 6, a high level block diagram of a system and process for log data mining according to embodiments of the invention is shown. During operation of operational units and/or a system, log and service data is generated and log record objects 607 are created. The log record objects 607 are available to a distributed processing system 601. Distributed processing system 601 comprises a distributed filing system 603 including a plurality of storage and/or processing devices. The storage and/or processing devices may be arranged in a cluster with some or all of the log and service data (e.g. log records 607) being stored across nodes in the cluster. A distributed data analytics processor 605 may process computer executable instructions 611, which when executed by the distributed data analytics processor 605, cause processor 605 to select certain log records of interest from the distributed file system 603. The selected records may be identified using queries 613. Once data is selected, additional processing by processor 605 includes data analysis 615 which processes the log record data selected by queries 613. Analysis 615 may be configured to identify and track a specific type of failure across a given type of operational unit. In addition or in the alternative, analysis 615 may be configured to perform pattern analysis across log records to identify normal operating states, or operating states during specific conditions. Analysis 615 is operable to produce representations such as models, patterns, or statistics that are of interest in pursuit a particular business need. For example, periodic maintenance schedules may be determined or updated based on certain patterns identified, which are indicative of wear or depletion of a particular type of operation unit. Distributed processing system 601, in cooperation with distributed data analysis processor 605, produces output records containing suggested predictive patterns 609 derived from the log and service data records 607 via analysis 615.

Given a collection of instances identified or obtained by the pre-processing described above, various approaches for modeling and pattern mining may be employed. For example, unsupervised methods may be used for anomaly detection. Common patterns may be extracted and used to build a profile of the stored data. Patterns may be identified based on established vectors, item sets or sequential patterns. Likewise, supervised techniques may also be employed to perform functions such as failure type diagnosis, preventative maintenance and/or failure predictions, and discriminative sequential pattern mining. These approaches should be appropriate for application to large volumes of data. By way of example, APACHE™ SPARK™ MLib provides scalable implementations of analysis for multiple clusters and supervised classification methods for vector data. Other languages may also be used to implement methods according to embodiments of the disclosure. For example, methods may be implemented in R (e.g., using rmr), JAVA®, among other programming languages.

Implementations of scalable sequential pattern mining methods are also provided in various embodiments of the present disclosure. Consider that all sequential pattern mining methods begin from a collection of sequences (e.g., instances) and candidate patterns are evaluated against sequences in the collection. In distributed operating platforms, the collection is distributed across nodes in files or in memory (e.g. within distributed storage devices). Using distributed operating platforms, the evaluation of patterns may proceed in parallel. Distributed processing systems allow access to the data in distributed nodes through the distributed file system. Additionally, processing may be divided among separate nodes allowing the evaluation, processing and analysis of the distributed data to occur simultaneously across nodes. The distributed processing platform then combines the results of the parallel processing into a single output.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A system for performing data mining on log record data, comprising:
a distributed processing system comprising:
a plurality of distributed nodes, each node having at least one of a storage device and a data processing device; and
a distributed data analytics processor configured to perform queries on a set of log records to select at least a portion of the log records and store the selected log records in a plurality of the distributed nodes;
wherein the distributed data analytics processor is further configured to perform data analysis on the selected log records stored in the plurality of distributed nodes.

2. The system of claim 1, wherein the plurality of distributed nodes are arranged in a cluster.

3. The system of claim 1, wherein each of the plurality of distributed nodes comprises a distributed file system.

4. The system of claim 3, wherein each of the plurality of distributed nodes is in communication with each other distributed node via the distributed file system.

5. The system of claim 4, wherein communication between a first distributed node and a second distributed node is controlled at least in part by the distributed data analytics processor.

6. The system of claim 1, wherein the distributed data analytics processor is configured to add at least one node to the plurality of distributed nodes and to store a portion of the selected log records on a storage device of the added at least one node.

7. The system of claim 1, wherein the distributed data analytics processor is configured to arrange the selected log records according to an operational unit associated with at least one of the log records in the set of log records and a time window associated with the operation unit.

8. The system of claim 1, wherein the distributed data analytics processor is configured to produce information corresponding to suggested predictive patterns representative of information contained in the set of log records.

9. The system of claim 8, wherein the suggested predictive patterns relate to at least one instance of a specific failure of an operational unit.

10. The system of claim 8, wherein the suggested predictive patterns relate to at least one normal utilization model of an operational unit.

11. The system of claim 10, wherein the at least one normal utilization model relates to a specific pre-determined operating condition.

12. The system of claim 10, wherein the suggested predictive patterns are indicative of a periodic maintenance operation.

13. The system of claim 1, the distributed data analytics processor is configured to perform the data analysis in a plurality of data processing devices of the distributed nodes, the processing being performed simultaneously in parallel.

14. A method for performing data mining on log record data comprising:
in a distributed data analytics processor, selecting a plurality of log records from a set of log records;
storing the selected log records in a plurality of distributed nodes; and
in the distributed data analytics processor, performing data analysis on the selected log records, wherein the analysis is performed in part by at least one data processing device associated with one of the plurality of distributed nodes.

15. The method of claim 14, further comprising:
arranging the plurality of distributed nodes in a cluster.

16. The method of claim 14, further comprising:
establishing communication between each node of the plurality of distributed nodes to each other distributed node via a distributed file system.

17. The method of claim 16, further comprising:
in the distributed data analytics processor, controlling at least part of the communication between a first node and a second node of the plurality of distributed nodes.

18. The method of claim 14, further comprising:
in the distributed data analytics processor, performing the data analysis in a plurality of processing devices, each processing device associated with one of the distributed nodes, wherein the data analysis is performed on the plurality of processing devices simultaneously in parallel.

19. A non-transitory computer readable medium storing computer instructions that when executed by a processor cause the processor to perform the steps of:
in a distributed data analytics processor, selecting a plurality of log records from a set of log records;
storing the selected log records in a plurality of distributed nodes; and
in the distributed data analytics processor, performing data analysis on the selected log records, wherein the analysis is performed in part by at least one data processing device associated with one of the plurality of distributed nodes.

20. The non-transitory computer readable medium of claim 19, further containing computer instructions that when executed by the processor cause the processor to perform the step of:
in the distributed data analytics processor, performing the data analysis in a plurality of processing devices, each processing device associated with one of the distributed nodes, wherein the data analysis is performed on the plurality of processing devices simultaneously in parallel.
